(19) United States
(12) Patent Application Publication
(10) Pub. No.: US 2024/0084482 A1
(43) Pub. Date: Mar. 14, 2024

(54) MANUFACTURING METHOD OF CARBON PRECURSOR FIBER FOR GAS DIFFUSION LAYER

(71) Applicants: Hyundai Motor Company, Seoul (KR); Kia Corporation, Seoul (KR); Ulsan National Institute of Science and Technology, Ulsan (KR)

(72) Inventors: Seo Hyun Yoon, Anyang (KR); Han Gi Chae, Ulsan (KR); Chang Beom Jeon, Ulsan (KR); Hye Jin Ju, Ulsan (KR)

(21) Appl. No.: 18/147,870

(22) Filed: Dec. 29, 2022

(30) Foreign Application Priority Data
Sep. 14, 2022 (KR) 10-2022-0115760

(51) Int. Cl. D01D 1/02; D01D 5/06; D01F 9/24; D01F 9/32

(52) U.S. Cl. CPC D01D 1/02; D01D 5/06; D01F 9/24; D01F 9/328

(57) ABSTRACT

Proposed is a method of manufacturing a carbon precursor fiber for a gas diffusion layer having excellent tensile properties (e.g., strength and modulus) by controlling the cross-sectional shape of carbon fiber. The method includes preparing a polyacrylonitrile-based copolymer, preparing spinning products by spinning a spinning solution containing the polyacrylonitrile-based copolymer in a coagulation bath, and obtaining a carbon precursor fiber by drawing the spinning products through heat treatment. The coagulation bath includes an amount of about 60% to 90% by volume of methanol and an amount of about 10% to 40% by volume of dimethylformamide based on the total volume of the coagulation bath.

The present application claims priority to Korean Patent Application No. 10-2022-0115760, filed Sep. 14, 2022, the entire contents of which is incorporated herein for all purposes by this reference.

### TECHNICAL FIELD

The present disclosure relates to a method of manufacturing a carbon precursor fiber for a gas diffusion layer.

### BACKGROUND

A fuel cell is driven by the principle of generating electrons by using the oxidation/reduction reaction of oxygen and hydrogen and is a key component of a hydrogen-electric vehicle. In addition, a fuel cell is typically composed of a membrane electrode assembly (MEA), a gas diffusion layer (GDL), a separator, a current collector, and the like. Specifically, a flow path exists in the separator to allow hydrogen and oxygen to flow toward the membrane electrode assembly, and the membrane electrode assembly serves to generate power through oxidation/reduction reactions. In addition, the gas diffusion layer serves to allow hydrogen and oxygen to diffuse into the membrane electrode assembly to facilitate the reaction and is typically composed of a base layer and a porous layer. In this case, the base layer serves to impart rigidity to the porous layer, and the porous layer serves to allow hydrogen and oxygen to diffuse into the membrane electrode assembly so that the oxidation/reduction reaction proceeds smoothly.

The conventional gas diffusion layer has a structure in which a microporous layer is laminated on a carbon substrate. Meanwhile, in order to miniaturize and increase the power of the stack, the development of a thin film of a gas diffusion layer is in progress in a recent substrate configuration. However, since the gas diffusion layer is broken by the fastening pressure of the stack as the thin film proceeds, it is difficult to implement a thin film of 185 μm or less.

Therefore, it is necessary to develop a technology for thinning the gas diffusion layer while maintaining the rigidity of the gas diffusion layer due to the background described above.

### SUMMARY

In preferred aspects, provided is a method of manufacturing a carbon precursor fiber for a gas diffusion layer. The method can provide a thin a gas diffusion layer by improving tensile properties (strength and modulus) through control of the cross-sectional shape of the carbon fiber.

Objectives of the present disclosure are not limited to the objective mentioned above. Other objectives of the present disclosure will become more apparent from the following description and will be realized by means and combinations thereof described in the claims.

In an aspect, provided is a method of manufacturing a carbon precursor fiber for a gas diffusion layer. The method includes: preparing a polyacrylonitrile-based copolymer; preparing a spinning product by spinning a spinning solution including the polyacrylonitrile-based copolymer in a coagulation bath; and manufacturing the carbon precursor fiber by drawing the spinning product through heat treatment. The coagulation bath may suitably include an amount of about 60% to 90% by volume of methanol and an amount of about 10% to 40% by volume of dimethylformamide based on the total volume of the coagulation bath.

The term “polyacrylonitrile-based copolymer” as used herein refers to a resin (e.g., copolymer) having acrylonitrile monomers (—[CH₂—CH(CN)]—) as dominant units. For example, the polyacrylonitrile-based copolymer includes acrylonitrile monomers constituting greater than about 50% by mass, greater than about 55% by mass, greater than about 60% by mass, greater than about 65% by mass, greater than about 70% by mass, greater than about 75% by mass, greater than about 80% by mass, greater than about 85% by mass, greater than about 90% by mass, greater than about 95%, greater than about 96%, greater than about 97%, greater than about 98%, or greater than about 99% by mass of the total molecular mass of the polyacrylonitrile-based copolymer.

The polyacrylonitrile-based copolymer may be prepared by free radical polymerization reaction of dimethyl sulfoxide and acrylonitrile using azobisisobutyronitrile as an initiator.

The polyacrylonitrile-based copolymer may suitably include less than about 4% by weight of methacrylic acid.

The polyacrylonitrile-based copolymer may suitably have a viscosity average molecular weight (Mv) in a range of about 400,000 to 460,000 g/mol.

The spinning solution may suitably be obtained by dissolving the polyacrylonitrile-based copolymer in a solvent to have a concentration of about 5 to 30 g/dL.

The spinning solution may suitably be obtained by dissolving the polyacrylonitrile-based copolymer in a solvent at a temperature of about 65° C. to 70° C.

The solvent may suitably include dimethylformamide.

The spinning solution may suitably have a dynamic viscosity of about 90 to 110 Pa·s measured by a rotation rheometer at a shear rate of 0.06 rad/sec.

The spinning may be performed by discharging the spinning solution through a nozzle having a diameter of about 150 to 250 μm and a discharging speed of about 5 to 10 m/min.

The spinning may suitably be performed in a condition in which the temperature of the coagulation bath is in a range of about −10° C. to 30° C.

The drawing may suitably be performed at a temperature in a range of about 70° C. to 160° C.

The drawing may suitably be performed with a stretching ratio of about 10 to 30.

The spinning products may suitably have a roundness of about 0.45 to 0.75, and a cross-sectional circularity of about 0.50 to 0.71.

The carbon precursor fiber may suitably have a cross-sectional roundness of about 0.45 to 0.75, and a cross-sectional circularity of about 0.50 to 0.71.

Also provided is a carbon precursor fiber manufactured by the method as described herein.

In another aspect, provided is a gas diffusion layer for a fuel cell, and the gas diffusion layer may include the carbon precursor fiber as described herein.

Further provided is a fuel cell including the gas diffusion layer as described herein.

Provided is a vehicle including the fuel cell as described herein.

The method of manufacturing a carbon precursor fiber for a gas diffusion layer, according to various exemplary embodiments of the present disclosure, can produce a high-quality fiber having excellent tensile properties (strength and modulus) by controlling the cross-sectional shape of a carbon fiber.

In addition, the carbon precursor fiber manufacturing method, according to various exemplary embodiments of the present disclosure, can change the cross-sectional shape of a carbon fiber to any shape with directionality such as an oval shape aside from a circular shape through precursor preparation, spinning, stretching, etc.

In addition, since the carbon precursor fiber manufactured by the manufacturing method of the present disclosure has excellent tensile properties (strength and modulus), the carbon precursor fiber can contribute to thinning a gas diffusion layer.

The effects of the present disclosure are not limited to the effects mentioned above. It should be understood that the effects of the present disclosure include all effects that can be inferred from the following description. Other aspects of the invention are disclosed infra.

### BRIEF DESCRIPTION OF THE DRAWINGS

FIG. 1 shows an exemplary cross-sectional structure of a fuel cell unit including a gas diffusion layer to which a carbon precursor fiber manufactured by a manufacturing method according to an exemplary embodiment of the present disclosure is applied;

FIG. 2 shows an exemplary method of manufacturing an exemplary carbon precursor fiber according to an exemplary embodiment of the present disclosure;

FIGS. 3 to 4 show the results of evaluation of the physical properties of the fiber according an exemplary embodiment of to the present disclosure;

FIGS. 5 and 7 show measurement values of tensile properties (strength and modulus) of the fiber according to an exemplary embodiment of the present disclosure; and

FIG. 6 shows a measurement value of an alignment factor according to changes in the draw ratio of the fiber according to an exemplary embodiment of the present disclosure.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where another part is in the middle. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases. Further, unless specifically stated or obvious from context, as used herein, the term “about” is understood as within a range of normal tolerance in the an, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when a numerical range is disclosed in this disclosure, this range is continuous and includes all values from the minimum to the maximum value containing the maximum value of this range unless otherwise indicated. Furthermore, when such a range refers to an integer, all integers including the minimum value to the maximum value containing the maximum value, are included unless otherwise indicated.

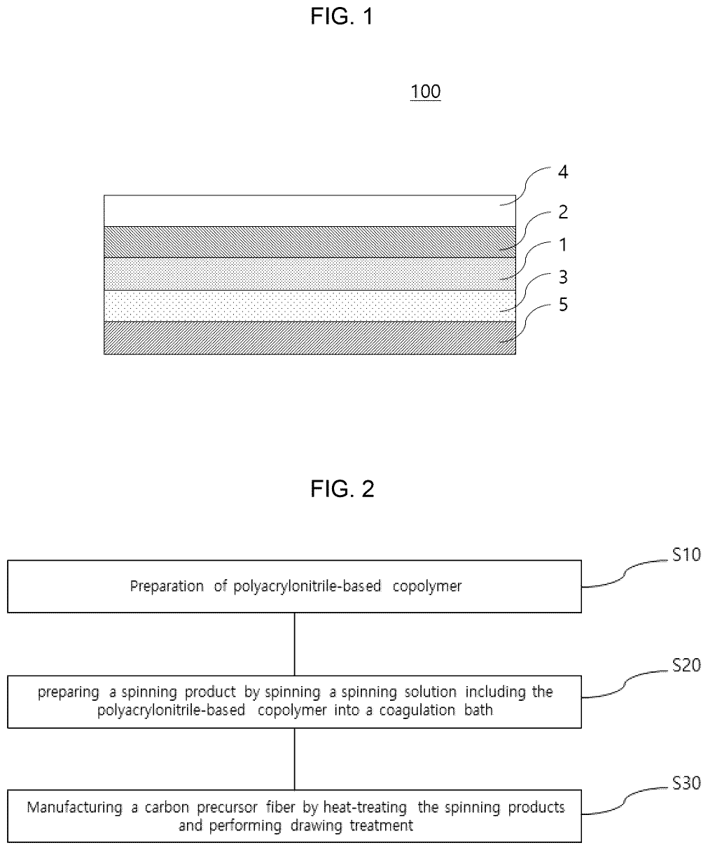

Before describing the present disclosure, the present disclosure relates to a manufacturing method of a carbon precursor fiber that can be applied for a gas diffusion layer. FIG. 1 is a schematic diagram showing an exemplary cross-sectional structure of a fuel cell including a gas diffusion layer to which a carbon precursor fiber manufactured by a manufacturing method according to the present disclosure is applied. Referring to FIG. 1, a fuel cell 100 may include an anode-side catalyst layer 2, a cathode-side catalyst layer 3, an electrolyte membrane 1 disposed between the anode-side catalyst layer 2 and the cathode-side catalyst 3, and gas diffusion layers 4 and 5. The present disclosure may be applied to the gas diffusion layers 4 and 5 used for fuel cells. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In general, a vehicle including a fuel cell (hereinafter referred to as a “fuel cell vehicle”) requires various levels of power from the fuel cell. When a relatively high level of power is required from the fuel cell, the volume of the fuel cell mounted within the vehicle may increase. As a result, the amount of space occupied by the fuel cell in the fuel cell vehicle increases, which may cause various problems.

The present disclosure relates to a method of manufacturing a carbon precursor fiber for a gas diffusion layer. Hereinafter, the present disclosure will be described in more detail with reference to the accompanying drawings. FIG. 2 is a flowchart illustrating a carbon precursor fiber manufacturing method according to the present disclosure.

As shown in FIG. 2, a carbon precursor fiber method of manufacturing a carbon precursor fiber includes: preparing a polyacrylonitrile-based copolymer S10 and spinning a spinning solution containing the polyacrylonitrile-based copolymer into a coagulation bath. The method further includes: preparing a spinning product by spinning the spinning solution containing the polyacrylonitrile-based copolymer into a coagulation bath S20; and producing a carbon precursor fiber by drawing the spinning product through heat treatment S30. Particularly, the coagulation bath used in step S20 may include an amount of about 60% to 90% by volume of methanol and an amount of about 10 to 40% by volume of dimethylformamide based on the total volume of the coagulation bath.

Next, each step of the thin film coating method according to the present disclosure will be described in detail below.

First, in step S10, a polyacrylonitrile-based copolymer is prepared.

The polyacrylonitrile-based copolymer may have a co-monomer added thereto for stable structural change between polymers in a heat treatment process described below.

The polyacrylonitrile-based copolymer may include a polymer based on polyacrylonitrile (PAN) and obtained by copolymerizing methacrylic acid (MAA) in order to prepare a high-performance precursor.

The polyacrylonitrile-based copolymer may be prepared in the form of a high-purity polymer powder by a free radical solution polymerization method using azobisisobutyronitrile as an initiator.

Particularly, the polyacrylonitrile-based copolymer may be prepared by free radical polymerization reaction of dimethyl sulfoxide and acrylonitrile using azobisisobutyronitrile as an initiator.

The polyacrylonitrile-based copolymer may include less than about 4% by weight of methacrylic acid based on the total weight thereof.

Particularly, the polyacrylonitrile-based copolymer may contain acrylonitrile in an amount of about 96.2±0.2 mol % and methacrylic acid in an amount of about 3.8±0.2 mol % based on the total weight thereof.

The polyacrylonitrile-based copolymer may be a high molecular weight polymer in terms of manufacturing a high-performance precursor fiber. The polyacrylonitrile-based copolymer may be a high-purity polymer, and thus stability in stabilization and carbonization processes may be secured.

The polyacrylonitrile-based copolymer may have a viscosity average molecular weight (Mv) in a range of about 400,000 to 460,000 g/mol. For example, the polyacrylonitrile-based copolymer may have a viscosity average molecular weight (Mv) of 454,891 g/mol.

Here, “viscosity average molecular weight (Mv)” means the average molecular weight obtained by measuring the viscosity of a solution in a dilute solution to determine the size of a solute polymer, i.e., the average molecular weight. The average molecular weight determined by the method is called viscosity average molecular weight.

Then, in step S20, a spinning solution including the polyacrylonitrile-based copolymer is spun into a coagulation bath to prepare spinning products.

In step S20, the spinning products may be prepared using a dry-jet wet spinning method or a wet spinning method.

The spinning solution may be obtained by dissolving the polyacrylonitrile-based copolymer in a solvent to a concentration of 5 to 30 g/dL. When the spinning solution concentration is higher than the above range, there is a problem in that the surface becomes non-uniform due to rapid solidification.

The spinning solution may be obtained by dissolving the polyacrylonitrile-based copolymer in a solvent at a temperature of about 65° C. to 70° C.

The solvent may suitably include dimethylformamide.

The spinning solution may have a dynamic viscosity of about 90 to 110 Pa·s measured by a rotation rheometer at a shear rate of 0.06 rad/sec.

In step S20, the discharging speed of the spinning may be set to about 5 to 10 m/min and the spinning solution may be discharged through a nozzle having a diameter of about 150 to 250 μm.

“Coagulation bath” means a liquid bath for coagulating a spinning solution.

The coagulation bath may include an amount of about 60% to 90% by volume of methanol and an amount of about 10% to 40% by volume of dimethylformamide. The spinning may be performed in a condition in which the temperature of the coagulation bath is in a range of about −10° C. to 30° C.

As the proportion of methanol in the composition increases, there is a problem in that the tensile strength decreases due to decrease in chain alignment. Therefore, the coagulation bath is most advantageous in terms of tensile strength when methanol is contained in an amount of about 60% to 90% by volume.

As the temperature of the coagulation bath decreases, the tensile properties improve. Therefore, preferably, the coagulation bath is performed at a temperature of about −10° C.

In addition, when methanol and dimethylformamide are appropriately mixed in a volume mixing ratio within the above-described range, the surface of the fiber is not rapidly solidified, and the drawing process is thus stably performed so that the even surface can be obtained.

The spinning products manufactured in step S20 may have a roundness of about 0.45 to 0.75 and a cross-sectional circularity of about 0.50 to 0.71.

Roundness represents the symmetry with respect to the major axis and the minor axis of a circle, and circularity represents how close the shape of the figure is to the circle.

Accordingly, circularity and roundness are measured by Formulae 1 and 2 below.

Circularity=4*π*A/([Circumference]²) [Formula 1]

Here, A is the projected area.

Roundness=4*π*A/([π*major axis]²) [Formula 2]

Here, A is the projected area

Finally, in step S30, the carbon precursor fiber is manufactured by drawing the spinning products through heat treatment.

The drawing may be performed at a temperature in a range of about 70° C. to 160° C.

When the draw ratio is increased, the tensile properties are improved, but the elongation is deteriorated. This is because the draw ratio affects the alignment of the polymer chain and the increase in directionality.

As the proportion of methanol in the composition increases, there is a problem in that the tensile strength decreases due to decrease in chain alignment. Therefore, the coagulation bath is most advantageous in terms of tensile strength when methanol is contained in an amount of about 60% to 90% by volume.

As the temperature of the coagulation bath decreases, the tensile properties improve. Therefore, preferably, the coagulation bath is performed at a temperature of about −10° C.

In addition, when methanol and dimethylformamide are appropriately mixed in a volume mixing ratio within the above-described range, the surface of the fiber is not rapidly solidified, and the drawing process is thus stably performed so that the even surface can be obtained.

The spinning products manufactured in step S20 may have a roundness of about 0.45 to 0.75 and a cross-sectional circularity of about 0.50 to 0.71.

Roundness represents the symmetry with respect to the major axis and the minor axis of a circle, and circularity represents how close the shape of the figure is to the circle.

Accordingly, circularity and roundness are measured by Formulae 1 and 2 below.

### Experimental Example 1 (Composition of Coagulation Bath)

First, to investigate the characteristics according to the content of methanol in a coagulation bath, a coagulation bath was prepared with the composition and content shown in Table 1 below.

TABLE 1

| Coagulation bath | MeOH | DMF |
|---|---|---|
| Solvent composition ratio* | (vol %) | (vol %) |
| MeOH 100% | 100 | 0 |
| MeOH 90% | 90 | 10 |
| MeOH 80% | 80 | 20 |
| MeOH 70% | 70 | 30 |
| MeOH 60% | 60 | 40 |

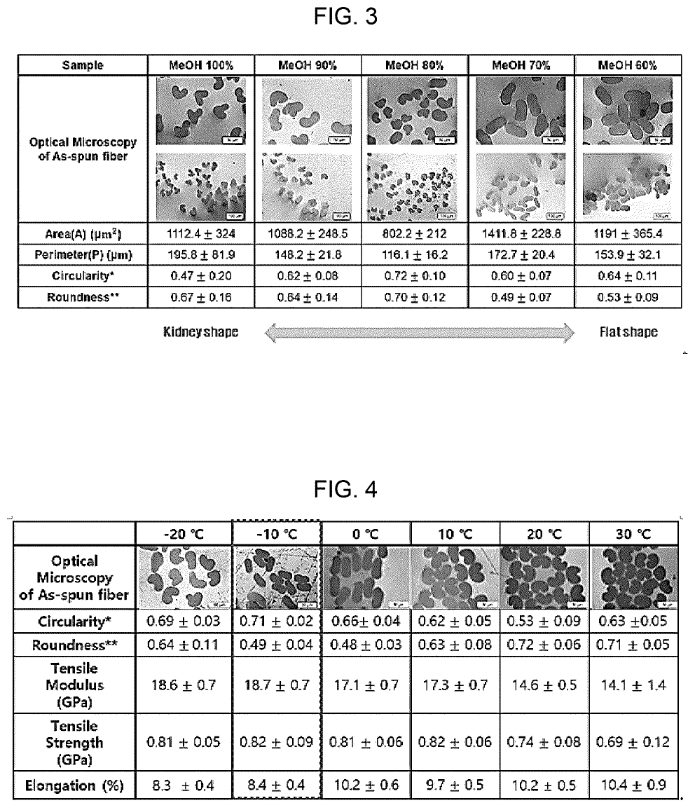

Then, the physical properties of spinning products spun into the coagulation bath were measured. The results are shown in FIG. 3. FIG. 3 shows the results of evaluation of physical properties of fibers according to the present disclosure.

Particularly, as-spun fibers were prepared by a wet spinning process while changing the composition of the coagulation solution using the spinning solution in which a polyacrylonitrile-based copolymer was dissolved at a concentration of 15 g/dL in a dimethylformamide solvent, and then drawing process was performed with a draw ratio of 3 times.

As shown in FIG. 3, as the composition ratio of methanol increases, chain alignment decreases, so there is a problem in that the tensile strength decreases. Therefore, it was confirmed that the most advantageous in terms of strength was when the coagulation bath contained 60% to 70% by volume of methanol and 30% to 40% by volume of dimethylformamide. In addition, it was confirmed that the surface shape was flat in the above range. In the specific spinning products, the roundness of the cross-section was 0.45 to 0.75, and the cross-sectional circularity was measured to be 0.50 to 0.71.

Therefore, according to an exemplary embodiment of the present disclosure, when methanol and dimethylformamide were appropriately mixed and used within the above range, the surface of the fiber was not rapidly solidified, and the drawing process was stably performed thereon to make the surface uniform, which is excellent in terms of strength.

### Experimental Example 2 (Coagulation Bath Temperature)

Subsequently, in order to find out the characteristics of the fibers according to the temperature of the coagulation bath, the physical properties of the spinning products spun to the coagulation bath was measured by setting the coagulation bath temperature in a range of −20° C. to 30° C.

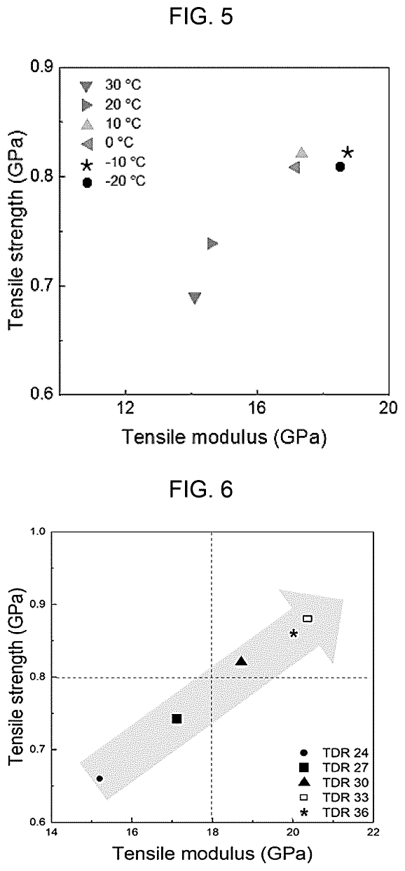

The results are shown in FIG. 4 and Table 5. FIG. 4 shows the results of the evaluation of the physical properties of fibers according to an exemplary embodiment of the present disclosure. FIG. 5 is a measurement of the tensile properties (strength, modulus) of the fiber according to an exemplary embodiment of the present disclosure.

As shown in FIGS. 4 and 5, as the temperature of the coagulation bath decreased, the roundness increased, and the circularity decreased in the cross section of the fiber.

In particular, when the temperature of the coagulation bath was −10° C., the flattest fiber cross-sectional shape could be obtained. In addition, it was confirmed that the tensile properties increased as the coagulation bath temperature was lowered. In particular, when the coagulation bath was −10° C., tensile properties (strength, modulus) were the best.

In addition, it can be seen that the tensile strength value was constant when the temperature was below 10° C., and the modulus value showed the highest value at −10° C. This is considered to be because the manufacturing method described above was close to the gel-spinning method, which can obtain high-quality fibers by spinning at a low temperature.

Therefore, the manufacturing method of a carbon precursor fiber for a gas diffusion layer, according to an exemplary embodiment of the present disclosure, a high-quality fiber having excellent tensile properties (strength, modulus) can be manufactured by controlling the cross-sectional shape of the carbon fiber.

### Experimental Example 3 (Draw Ratio)

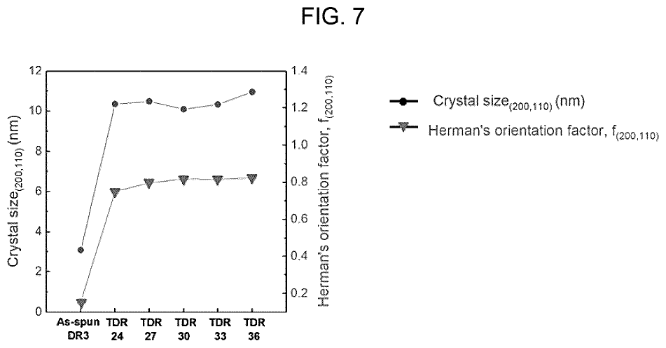

Subsequently, in order to investigate the characteristics of the fiber according to the draw ratio, the physical properties of the carbon precursor fiber with the draw ratio changed to 24 to 36 (TDR) were measured, and the results are shown in Table 2 and FIGS. 6 and 7. FIG. 6 shows a measurement of the tensile properties (strength, modulus) of the fiber according to the present disclosure. FIG. 7 shows a measurement of the alignment factor according to the draw ratio of the fiber according to the present disclosure.

TABLE 2

| Total | | Tensile | Tensile | |
|---|---|---|---|---|
| draw ratio | Diameter | strength | modulud | Elongation |
| (TDR) | (μm) | (GPa) | (GPa) | (%) |
| 24 | 14.3 ± 0.5 | 0.66 ± 0.06 | 15.2 ± 0.5 | 10.2 ± 0.6 |
| 27 | 12.4 ± 0.3 | 0.74 ± 0.06 | 17.1 ± 0.5 | 9.5 ± 0.3 |
| 30 | 11.7 ± 0.6 | 0.82 ± 0.09 | 18.7 ± 0.7 | 8.4 ± 0.4 |
| 33 | 11.3 ± 0.4 | 0.88 ± 0.04 | 20.5 ± 0.7 | 8.2 ± 0.3 |
| 36 | 11.2 ± 0.4 | 0.86 ± 0.06 | 20.0 ± 0.6 | 8.2 ± 0.3 |

As shown in Table 2 and FIGS. 6 and 7, when the draw ratio was increased, tensile properties were increased, but the elongation was decreased. This is because the draw ratio affects the alignment of the polymer chain and the increase in directionality.

Accordingly, when the draw ratio was excessively increased, defects in the fibers were generated, thereby reducing physical properties. In particular, it can be seen that the physical properties decreased from the draw ratio of TDR 36. Accordingly, the drawing process may be performed with a draw ratio of 10 to 35.

Therefore, the method of manufacturing a carbon precursor fiber for a gas diffusion layer, according to various exemplary embodiments of the present disclosure, can change the cross-sectional shape of a carbon fiber to any shape with directionality such as an oval shape aside from a circular shape through precursor preparation, spinning, stretching, etc.

In addition, since the carbon precursor fiber manufactured by the manufacturing method of carbon precursor fiber for the gas diffusion layer, according to various exemplary embodiments of the present disclosure, has excellent tensile properties (strength, modulus), it can be applied for thinning the gas diffusion layer.

Although the exemplary embodiment of the present disclosure has been described above, it will be understood by those skilled in the art that the present disclosure may be implemented in other specific forms without changing the technical spirit or essential features thereof. Therefore, it should be understood that the embodiments described above are illustrative in all respects and not restrictive.

What is claimed is:

1. A method of manufacturing a carbon precursor fiber for a gas diffusion layer,
preparing a polyacrylonitrile-based copolymer;
preparing a spinning product by spinning a spinning solution comprising the polyacrylonitrile-based copolymer into a coagulation bath; and
manufacturing the carbon precursor fiber by drawing the spinning products through heat treatment,
wherein the coagulation bath comprises an amount of about 60% to 90% by volume of methanol and an amount of about 10% to 40% by volume of dimethylformamide based on the total volume of the coagulation bath.

2. The method of claim 1, wherein the polyacrylonitrile-based copolymer is prepared by free radical polymerization reaction of dimethyl sulfoxide and acrylonitrile using azobisisobutyronitrile as an initiator.

3. The method of claim 1, wherein the polyacrylonitrile-based copolymer comprises less than about 4% by weight of methacrylic acid.

4. The method of claim 1, wherein the polyacrylonitrile-based copolymer has a viscosity average molecular weight (Mv) in a range of about 400,000 to 460,000 g/mol.

5. The method of claim 1, wherein the spinning solution is obtained by dissolving the polyacrylonitrile-based copolymer in a solvent at a concentration of about 5 to 30 g/dL.

6. The method of claim 1, wherein the spinning solution is obtained by dissolving the polyacrylonitrile-based copolymer in a solvent at a temperature of about 65° C. to 70° C.

7. The method of claim 5, wherein the solvent comprises dimethylformamide.

8. The method of claim 1, wherein the spinning solution has a dynamic viscosity of about 90 to 110 Pa·s measured by a rotation rheometer at a shear rate of 0.06 rad/sec.

9. The method of claim 1, wherein the spinning is performed by discharging the spinning solution through a nozzle having a diameter of about 150 to 250 μm and a discharging speed of about 5 to 10 m/min.

10. The method of claim 1, wherein the spinning is performed in a condition in which the temperature of the coagulation bath is in a range of about −10° C. to 30° C.

11. The method of claim 1, wherein the drawing is performed at a temperature in a range of about 70° C. to 160° C.

12. The method of claim 1, wherein the drawing is performed with a draw ratio of about 10 to 30.

13. The method of claim 1, wherein the spinning product has a cross-sectional roundness of about 0.45 to 0.75 and a cross-sectional circularity of about 0.50 to 0.71.

14. The method of claim 1, wherein the carbon precursor fiber has a cross-sectional roundness of about 0.45 to 0.75 and a cross-sectional circularity of about 0.50 to 0.71.

15. A carbon precursor fiber manufactured by a method of claim 1.

16. A gas diffusion layer for a fuel cell, comprising a carbon precursor fiber of claim 15.

17. A fuel cell comprising a gas diffusion layer of claim 16.

18. A vehicle comprising a fuel cell of claim 17.
